(19) United States
(12) Patent Application Publication
(10) Pub. No.: US 2007/0222759 A1
(43) Pub. Date: Sep. 27, 2007

(54) Computer pointing device

(76) Inventor: Cody C. Barnes, Poway, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/389,648

(22) Filed: Mar. 23, 2006

(51) Int. Cl. G09G 5/00

(52) U.S. Cl. 345/168

(57) ABSTRACT

A computer pointing device for use to move a screen curser much like a computer mouse. The device is adapted for engagement with a computer keyboard and features a pair of thumb levers that are positioned for isometric engagement by the user's thumbs when the user's hands are in the at home position used for typing on keyboards. Translation of the thumb levers in any direction or speed communicates a signal to an attached computer mimicking the movement. Switches to act as right or left mouse buttons are provided either adjacent to the thumb levers or engaged with the thumb levers.

### FIELD OF THE INVENTION

The present invention relates generally to input devices for computers commonly employed with graphic interface software. More particularly, the present invention relates to pointing and selection devices employed to move a curser to positions on a computer video display for selection of procedural options with the software.

### BACKGROUND OF THE INVENTION

Computers throughout the world as software has evolved, have generally adopted a graphical interface to allow the user to input commands or select options for the software to execute. Generally such graphic interfaces employ icons or screen areas in which a moveable curser must be positioned and a section switch operated, to choose the software command to which that point on the video display is related.

Computer input devices for moving the curser within such a graphic interface and for entering commands into a computer are well known and currently available in a variety of configurations. Such input pointing devices include the computer mouse or computer trackball which generally employ a rotatable ball mounted to the base of the pointing device. As the ball is moved relative to the base, transducers, or other means to sense the movement of the ball along between X and Y axises generate signals indicative of the direction, speed, and amount of that movement.

A common type of such input device is known as a “mouse,” and houses the rotatable ball so that it extends from the underside to frictionally engage a work surface, such as a desktop or mousepad. Moving the mouse along the work surface causes rotation of the encased ball and thereby generates electrical signals that are converted to cursor movement on the computer screen. A trackball style input device, on the other hand, uses a similar electronic signal generation scheme as the mouse, but has its rotatable ball exposed for manipulation by the user's finger(s) and/or thumb. A more recent style computer input and pointing device is the “touch pad” on which the user moves a finger to cause the electronic signals to be generated to move the curser on the display screen.

As a general rule, such computer pointing and input devices also include keys for inputting a command to the computer once a display screen position or icon has been engaged by the curser. Depressing one of these command keys changes the state of a communicating switch, which permits a user to enter various commands into the computer. The nature of the command usually depends upon the icon or position within the displayed software interface and the options associated with that position within the software being used.

Some models of the mouse and the trackball also include a roller or wheel that is engageable by the user's finger. Much like the ball of the mouse, this wheel is coupled to a transducer for producing a signal to communicate the direction and speed of rotation the wheel. This second signal is generally used to move within a graphic window that has been opened by activation of the command key or keys on the mouse or trackball.

A continuing problem with pointing devices such as the mouse and trackball is with the accuracy of their movement, especially where the curser on the screen must be directed very small distances or into tight quarters for some sort of software operation. With the mouse, fine movements are dependant on the ability of the user to move their hand accurately and in small increments. With the trackball fine movements or very short or accurate placements of the curser are dependant on the dexterity of the user's finger or thumb.

An additional problem with the use of a mouse or trackball is that of space. Conventional keyboards take up a lot of desk or rack space thereby relegating the mouse or keyboard to a side position. But because graphic oriented software requires constant repositioning of the curser to input commands and select options, the user is constantly removing their hand from the keyboard. Once finished operating the mouse or trackball, the user then has to properly reposition their hand on the keyboard. Such constant removing of the hand or hands to operate a pointing device is a constant cause of typographical errors from mis-positioning of the hands on the keyboard, and slows down operation of the computer because of the need to constantly remove and reposition the hands. Further, increased repetitive motions and awkward postures attributed to the use of conventional keyboards, trackballs, mouses, and trackpads continue to cause cumulative trauma disorders that are generally considered to be the most costly and severe disorders occurring in the office.

Accordingly, there exists an unfulfilled need for a computer engageable pointing device which will allow great precision in directing a curser to a desired point on a video display of a computer graphic interface. Such a device should easily incorporate into conventional keyboards and allow the user to operate the device with great accuracy, without the need to remove either hand from their respective positions on the keyboard. Such a device should allow for easy integration into deployed computers by using common standards and electronic signal generation to be communicated to the computer. Further, such a device should provide a means to reduce or eliminate cumulative trauma disorders to the hands of the user through the provision of better posture and functionality.

The device herein disclosed and described solves this problem of accurate movement of the curser by a hand or finger engaged pointing device. Instead of using an entire hand or just one finger or thumb to move the wheel or ball to generate the electronic signal to move the curser, the device herein allows for the use of two thumbs concurrently. Such a configuration provides for extremely accurate placement of the curser on the screen and for very fine movements of the curser. This is because both thumbs are engaged in opposite directions of force thereby allowing one thumb to provide movement and the other to provide resistance to that movement in one axis. In the axis perpendicular to the two engaged thumbs, the user still has two thumbs to very accurately control the movement of the curser from the electronic signals generated by the device relative to the movement of both thumbs.

Further, by placing the two thumb engaging levers on either side of the spacebar on a conventional keyboard, the user need not move either of their hands from its registered position above the keyboard. Positioning of the levers thus allows for quicker positioning of the curser since the thumbs which are already naturally positioned adjacent to the control levers can simply engage them and direct the curser to the proper position, again, without removing either hand from its position on the keyboard.

With respect to the above description, before explaining at least one preferred embodiment of the invention in detail, it is to be understood that the invention is not limited in its application to the details of construction and to the arrangement of the components or steps set forth in the following description or illustrated in the drawings. The various apparatus and methods of the invention are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other devices, methods and systems for carrying out the several purposes of the present disclosed device. It is important, therefore, that the objects and claims be regarded as including such equivalent construction and methodology insofar as they do not depart from the spirit and scope of the present invention.

Further objectives of this invention will be brought out in the following part of the specification, wherein detailed description is for the purpose of fully disclosing the invention without placing limitations thereon.

### SUMMARY OF THE INVENTION

The device herein described and disclosed is a computer pointer and command input component adapted for communicative engagement with a computer in place of a mouse, trackball, or similar pointing device. The device is adapted for inclusion onto a conventional computer keyboard used to input data into a computer, or it can be employed with the keyboard conventionally used on laptop style computers.

The device features a pair of thumb levers adapted on at least one side edge to removably engage with a human thumb. One of the pair of thumb levers is positioned adjacent to one side of the space bar conventionally employed on computer keyboards. The other of the pair of thumb levers is located on the opposite side of the space bar. Both of the thumb levers are positioned on the keyboard such that the thumbs of the hands of the keyboard user, when the hands are positioned in the “home” position, can rest just above and adjacent to the thumb levers. The two thumb levers are engaged to a connecting member such that movement of one thumb lever moves the other and vice versa.

The thumb levers have side surfaces and the facing side surfaces of both of the pair of thumb levers are adapted to easily engage with and disengage with the user's thumbs. In this fashion the user can engage the facing side surfaces of each respective thumb lever to operate the device to move the curser. Because the user engages the facing side surfaces immediately adjacent to the space bar, the pressure exerted by the thumbs on the respective thumb levers is isometric in nature. Equal pressure by both thumbs on their respective thumb lever will cause them to remain stationary. More force in a vector by one thumb will cause both connected thumb levers to slide in the direction of the force vector of the stronger thumb.

The connecting member is engaged with a transducer means to create an electronic signal based on the movement of the thumb levers in any direction along an X-Y axis. Movement horizontally naturally produces movement of the curser in the same fashion. Movement vertically moves the curser in that direction substantially perpendicular to the horizontal moment. Movement of the thumb levers at an angled vector will thus produce movement of the curser along the same angle on the video display.

The transducing means can be one or a plurality of such devices such as mechanically operated potentiometers, optical movement sensors such as light projecting on a pattern that is read for movement based on the direction of light reflecting from the pattern, magnetic motion sensors, or other means to track the speed and direction of the connecting member and translate it to electronic signals communicated to the computer to generate curser movement on the display screen.

The connecting member is best engaged with a means to center or return it to a neutral or default position to thereby return the thumb levers to the default position. This can be accomplished using springs or other means to bias the connecting member to the point of origin on an X-Y axis, or using a unique post rolling on a frusto conical support surface that naturally returns the connecting member and engaged thumb levers to a default position.

Command switching buttons which operate to input commands much like those on a mouse or trackball are provided by a rotational engagement of the outside edge of each thumb lever to the underlying connecting member. In this fashion the isometric outward force of the thumbs will move both thumb levers and the connecting member in the direction desired. Once the curser has been moved on the screen, a light force on top of the thumb lever will cause it to overcome a biasing means and trip a switch underneath the inside edge of the thumb lever. Thus, right and left “click” commands can be easily provided by this unique engagement of the thumb levers to the connecting member and switches. Of course a slightly less practical embodiment of the device could employ keyboard mounted command switches adjacent to the thumb levers so that the user could trip the required switch to input the required command. This type of command switch would require the thumb to be removed from the thumb lever to activate the switch, but would still allow the hands to stay in the “at home” position on the keyboard.

Finally, in the case of laptop computers, or keyboards where the protruding thumb levers might be inconvenient during transport, a means to allow the thumb levers to translate into and below the top surface of the keyboard can be provided. This is accomplished by a telescopic mounting of the supports for the connecting member to allow it and the engaged thumb levers to translate into the keyboard. Or, in a more complicated version, the thumb levers themselves could be telescopically engaged with the connecting member to allow them to slide in their engagement thereto and recess the thumb levers into the keyboard.

An object of this invention is to provide a pointing device for a computer that may be operated without removing the hands from their “at home” position for typing on the keyboard.

Another object of this invention is the provision of such a pointing device that allows for ultra precise movement of the curser by allowing for isometric engagement of two thumbs to provide force in a direction for movement.

Another object of this invention is to provide such a computer pointing device which allows the user to keep their hands in the proper typing position on the keyboard while moving the curser and/or operating the command switching buttons required once the curser is in position in the video display.

These together with other objects and advantages which become subsequently apparent reside in the details of the construction and operation as more fully hereinafter described and claimed, reference being had to the accompanying drawings forming a part thereof, wherein like numerals refer to like parts throughout.

### BRIEF DESCRIPTION OF THE ASSOCIATED DRAWINGS

FIG. 1 is a top plan view of a conventional keyboard showing the disclosed device operatively engaged therewith.

FIG. 2 depicts a side view of the device showing the two thumb levers communicating with a connecting member to allow for isometric operation of the device. The slanted outside surfaces allow for mouse operation with mechanical advantage and means to avoid mistaken inputs to the computer.

FIG. 3 is a top view of the thumb levers engaged on the connecting member and showing the X-Y axis of movement of the connecting member to vector the curser.

FIG. 4 is a perspective view of one of the thumb levers rotationally engaged with the connecting member on an outside edge to operate a command switch on the inside edge and an optical means to detect movement along the X-Y axis of the connecting member.

FIG. 5 depicts a mechanical means to generate electric signals to vector the curser in a video display using a geared engagement to potentiometers.

FIG. 6 depicts a means to bias the connecting member and thumb levers to a default centered position.

FIG. 7 shows a split thumb lever that would allow for operation of two command switches.

FIG. 8 shows a telescopic mount of the connecting member to allow the thumb levers to recess into the keyboard.

### DETAILED DESCRIPTION OF PREFERRED EMBODIMENTS OF THE DISCLOSED DEVICE

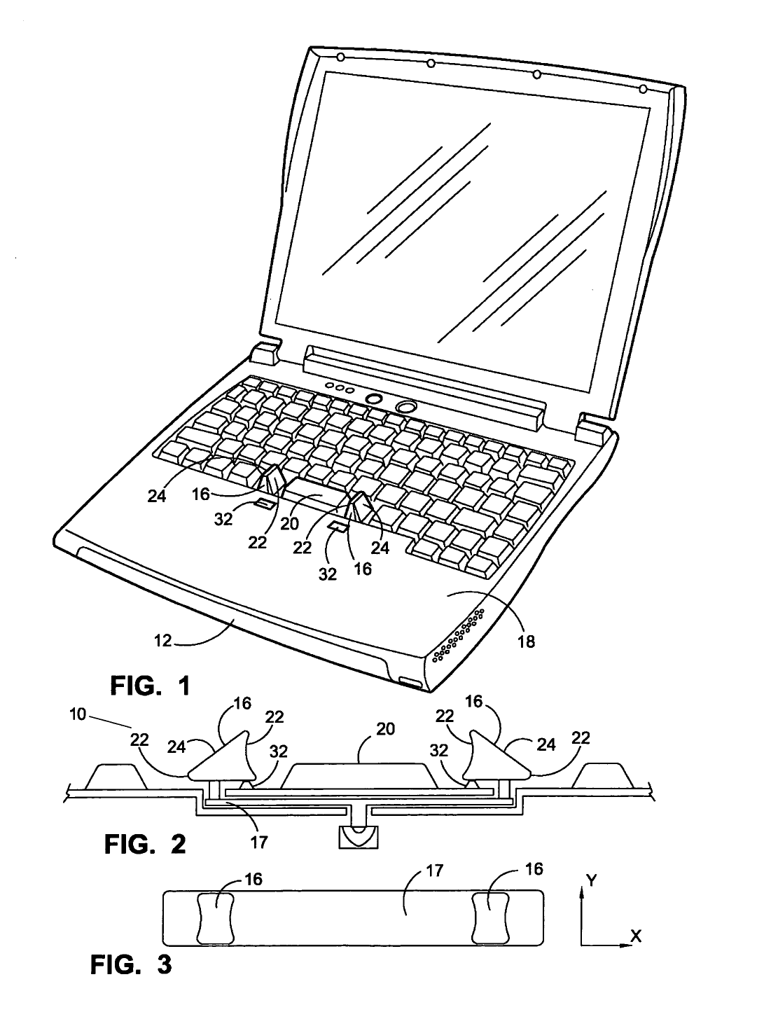

Referring now to the drawings in FIGS. 1-8, some preferred embodiments of the present invention in current preferred modes in accordance with the present invention are shown.

As depicted in an installed position in FIG. 1, the device 10 is best engaged with a keyboard 12 during manufacture of the keyboard 12 and can be employed on a keyboard 12 on a laptop or detached keyboard 12 for a desktop computer. The internal components of each keyboard being slightly different, the device 10 would be adapted for engagement with each keyboard 12 to allow for movement of a pair of thumb levers 16 along an X-Y axis and to points of intersection and along vectors in that axis, to provide a movement input means to a connected computer. The thumb levers 16 are both engaged to a connecting member 17 that is positioned below the keyboard top surface 18. The keyboard top surface 18 would thus have appropriate apertures therein to allow sufficient horizontal and vertical movement of both thumb levers 16 to the points on the X-Y axis for operation of the device 10.

A first of the pair of thumb levers 16 is operatively positioned adjacent to one side of the space bar 20 employed on conventional computer keyboards. The second one of the pair of thumb levers 16 is positioned on the opposite side of the space bar 20. It is important that both thumb levers 16 are positioned on the keyboard 12 to allow their operation by the thumbs of the user, without moving their hands from the conventional “home” position occupied by the hands of the user poised for typing.

Each thumb lever has an outward facing outer surface 24 and an opposing inner side surface 22 closest to the space bar 20 which is dimensioned to easily and comfortably engage with and disengage with the user's thumbs during use. In this fashion the user can engage the opposing inner side surfaces 22 of each respective thumb lever 16 concurrently with both thumbs, to operate the device 10 and thereby move the curser in a video display of a communicating computer. The opposing inner side surfaces 22 thereby provide a means for isometric engagement of both thumbs of the user to translate the connecting member 17 and thereby allow both thumbs to control movement. A number of shapes for the thumb levers 16 are shown in the drawings and all would work well depending on the user preferences.

As best shown in FIG. 2 a particularly favored embodiment of the device features the outer surfaces 24 being slanted to provide activation of the command switches 32 if they are slanted or highly angled such that the outer surface 24 is longer than the inner surface 22 and at an acute angle to provide a means for mechanical advantage of the tilting of the thumb lever to activate the command switch 32. These slanted outside surfaces 24 rise at an obtuse angle to the top surface of the keyboard and thereby also allow for a lower profile of the thumb levers in relation to the keyboard and help the user avoid typing mistakes when traversing their thumbs or fingers over the thumb levers 16 and accidental activations of the command switch or mouse movements on the screen.

Of course the outer surfaces 24 might also be employed in an isometric engagement of the thumbs if the user prefers inward opposing force to the outward opposing or isometric force of the thumbs against each other, this would require a reversal of rotation of the thumb levers 16 to operate the select action of the mouse; however, the current preferred mode is with the thumbs imparting force in opposite or isometric directions on the inner surfaces 22. As noted above, using two thumbs isometrically or in opposing directions provides for increased accuracy on fine movements and also short distance movements thereby markedly increasing the accuracy of the curser which follows the movements of the device 10.

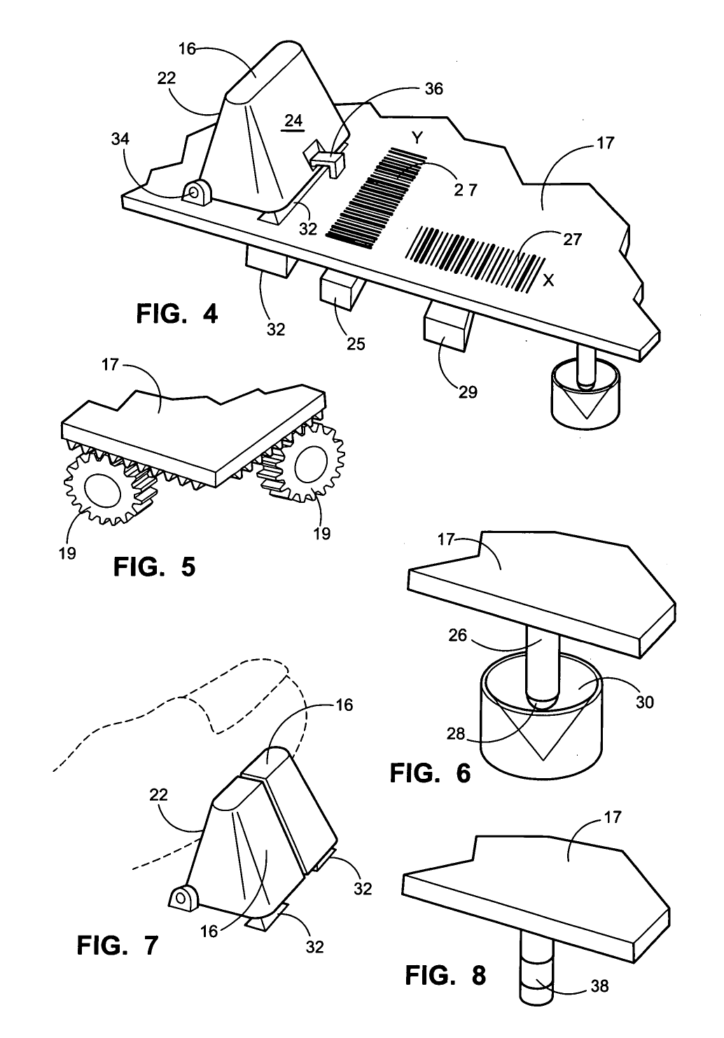

To provide the electronic signal to a communicating computer to cause the curser to move on the video display in the conventional fashion, the connecting member 17 employs a movement detection input means that detects movement in any direction along the x-y axis of the connecting member 17 and generates an electronic signal that can be read by the mouse input means of a computer. As shown, a transducer is employed as a means to generate an electronic signal relative to the movement of the thumb levers 16 which move the engaged connecting member 17 along any vector of the X-Y axis. The movement detection means can be one or a plurality of movement detection devices such as mechanically operated potentiometers 19, shown in FIG. 5, optical movement sensors 25 such as light projecting on a pattern that is read for movement based on the direction of light reflecting from the pattern 27 as shown in FIG. 4, magnetic motion sensors 29, or other means to track both the speed and direction of the connecting member 17 along any vector of the x-y axis and generate electronic signals communicated to the computer to provide matching curser movement for speed and direction mimicking that of the connecting member 17 on the display screen.

In order to maintain the thumb levers 16 in the proper position for the user to easily contact them without moving their hands from the “home position,” the device 10 performs best if they return to a default position, substantially equidistant from the distal ends of the space bar 20, once the thumbs disengage. This means to return the thumb levers 16 to a default position, is provided by means to center or return the connecting member 17, to which they are engaged, to a neutral or default position. This can be accomplished using springs (not shown) or other conventional means to bias the connecting member to the point of origin on an X-Y axis, or in a particularly favored mode of the device 10 using a unique post 26 projecting from the bottom of the connecting member 17 supporting it. The distal end of the post 26 has an engaged ball 28 which rolls on a frusto conical support surface 30 and naturally settles at the lowest point on that support surface 30, when force from the thumbs ceases.

Command switches 32 are provided to operate to input commands to the computer much like those on a mouse or trackball. They can either be placed on the keyboard 12 in positions depressable without removal of the hands from the “home” position, or in an especially preferred mode, operatively communicating with bottom side of the thumb levers 16. In this mode of the device, a means for rotational engagement of the outside edge of each thumb lever 16 to the underlying connecting member 17 is provided in the form of hinged engagement 34 or some other means to allow rotation. The lower inside edge of each thumb lever 16 is positioned to contact with the command switch 32 when the thumb lever rotates toward the space bar 20. A stop 36 or other means to prevent rotation of the thumb lever 16 away from the space bar 20 would allow for isometric engagement by both thumbs in that direction. As noted, this can be reversed if the user prefers an inward force for the isometric action of the two thumbs on the device 10. Cessation of outward isometric force by the user's thumbs and replacing it with a slight inward force will rock the thumb lever 16 to activate the command switch 32 which would be conventionally biased in the open position. Right and left “click” commands required for the graphic interface can be thus easily provided by this unique rocking engagement of the thumb levers 16 to the connecting member 16 and closing the command switches 32 which would return to their biased position once pressure ceases.

Additionally, as noted, in cases where the protruding thumb levers 16 might be inconvenient during transport or storage, a means to translate the thumb levers 16 toward or below the top surface 18 of the keyboard 12 is provided. Sinking of the thumb levers 18 into the keyboard 12 is provided by a telescopic configuration 38 of a support member 26 which would provide a means for the connecting member 17 and attached thumb levers 16 to drop along the X axis to recess the thumb levers toward and into the keyboard 12.

Although the invention has been described with respect to particular embodiments thereof, it should be realized that various changes and modifications may be made therein without departing from the spirit and scope of the invention. While the invention as shown in the drawings and described in detail herein discloses arrangements of elements of particular construction and configuration for illustrating preferred embodiments of structure and method of operation of the present invention, it is to be understood, however, that elements of different construction and configuration and other arrangements thereof, other than those illustrated and described, may be employed in accordance with the spirit of this invention. Any and all such changes, alternations and modifications as would occur to those skilled in the art are considered to be within the scope of this invention as broadly defined in the appended claims.

Further, the purpose of the attached abstract is to enable the U.S. Patent and Trademark Office and the public generally, and especially the scientists, engineers and practitioners in the art who are not familiar with patent or legal terms or phraseology to determine quickly from a cursory inspection the nature and essence of the technical disclosure of the application. The abstract is neither intended to define the invention of the application, which is measured by the claims, nor is it intended to be limiting as to the scope of the invention in any way.

What is claimed is:

1. A computer pointing device adapted for engagement with a: computer keyboard having a top surface with keys projecting therefrom comprising:
a first thumb lever having an inner side surface and an outer side surface opposite said inner side surface;
a second thumb lever having an inner side surface and having an outer side surface opposite said inner side surface;
a connecting member engaged between said first thumb lever and said second thumb lever;
means for translatable engagement of said connecting member to said keyboard;
means to bias said connecting member to a default position;
said first thumb lever and said second thumb lever positioned for isometric engagement thereon, by the thumbs of a user having their hands in an at home position on said keyboard, when said connecting member is in said default position;
movement detection means for detecting a direction and a speed of a movement of said connecting member;
means to generate an electronic signal relative to said movement of said connecting member;
means to communicate said electronic signal to said computer; and
whereby a curser on a video display of said computer can be manipulated by said user by movement of said two thumbs when in said isometric engagement.

2. The computer pointing device of claim 1 additionally comprising:
at least one means for electronic switching having a static position and having a signal generating position wherein an input signal is communicated to said computer; and
said means for electronic switching positioned to be operable by one of said two thumbs of said user to provide said input signal to said computer when moved to said signal generating position by said one of said two thumbs.

3. The computer pointing device of claim 1 additionally comprising:
said first thumb lever and said second thumb lever positioned for said isometric engagement such that said isometric engagement is achieved by engagement of said thumbs of said user with each of a respective inner surface of said first thumb lever and said second thumb lever, said respective inner surfaces being closest to a space key on said keyboard, whereby said curser is manipulated by said two thumbs imparting unequal opposing force to said respective inner surfaces.

4. The computer pointing device of claim 2 additionally comprising:
said first thumb lever and said second thumb lever positioned for said isometric engagement such that said isometric engagement is achieved by engagement of said thumbs of said user with each of a respective inner surface of said first thumb lever and said second thumb lever, said respective inner surfaces being closest to a space key on said keyboard, whereby said curser is manipulated by said two thumbs imparting unequal opposing force to said respective inner surfaces.

5. The computer pointing device of claim 2 additionally comprising:
at least one thumb lever from said first thumb lever and said second thumb lever rotatably engaged to said connecting member at a first bottom edge;
said means for electronic switching communicating with a second bottom edge opposite said first bottom edge; and
said means for electronic switching moveable to said signal generating position by rotation of said one thumb lever in a direction away from said first bottom edge toward said second bottom edge, whereby said user can communicate said input signal to said computer exerting force said at least one thumb lever along a side edge terminating at said first bottom edge.

6. The computer pointing device of claim 3 additionally comprising:
at least one thumb lever from said first thumb lever and said second thumb lever rotatably engaged to said connecting member at a first bottom edge adjacent at an intersection of said outer surface of said at least one thumb lever and said connecting member;
said means for electronic switching communicating with a second bottom edge opposite said first bottom edge; and
said means for electronic switching moveable to said signal generating position by rotation of said one thumb lever in a direction away from said first bottom edge toward said second bottom edge, whereby said user can communicate said input signal to said computer exerting force upon said outer surface of said at least one thumb lever.

7. The computer pointing device of claim 4 additionally comprising:
at least one thumb lever from said first thumb lever and said second thumb lever rotatably engaged to said connecting member at a first bottom edge adjacent at an intersection of said outer surface of said at least one thumb lever and said connecting member;
said means for electronic switching communicating with a second bottom edge opposite said first bottom edge; and
said means for electronic switching moveable to said signal generating position by rotation of said one thumb lever in a direction away from said first bottom edge toward said second bottom edge, whereby said user can communicate said input signal to said computer exerting force upon said outer surface of said at least one thumb lever.

8. The computer pointing device of claim 2 additionally comprising:
said first thumb lever and said second thumb lever rotatably engaged to said connecting member at a respective first bottom edge;
said means for electronic switching having switching components attached to both of said first thumb lever and said second thumb lever thereby yielding two means for electronic switching;
one of said switching components communicating with a respective second bottom edge of said first thumb lever and the other of said two switching components communicating with a respective second bottom edge of said second thumb lever, opposite said respective first bottom edge; and
each said two means for electronic switching moveable to said signal generating position by rotation of said respective first thumb lever and second thumb lever, in a direction away from said respective first bottom edge toward said respective second bottom edge, whereby said user can communicate two different of said input signals to said computer by exerting force on either of said first thumb lever or said second thumb lever along a respective side edge terminating at said first bottom edge, and can communicate a third said input signal to said computer by exerting forth on both said thumb levers on respective side edges terminating at respective said first bottom edges, concurrently.

9. The computer pointing device of claim 3 additionally comprising:
said first thumb lever and said second thumb lever rotatably engaged to said connecting member at a respective first bottom edges adjacent to said connecting member, of said respective outer surfaces of said first thumb lever an said second thumb lever;
said means for electronic switching having a first switching component adapted for generating a first said input signal when moved to an activated position;
said means for electronic switching having a second switching component adapted for generating a second said input signal when moved to an activated position;
said first switching component moved to said activated position by rotation of said first thumb lever by exerting force on said outer surface of said first thumb lever;
said first switching component moved to said activated position by rotation of said second thumb lever by exerting force on said outer surface of said second thumb lever; and
whereby said user can communicate said first input signal to said computer by rotation of said first thumb lever and said second input signal by rotation of said second thumb lever and can communicate a third input signal to said computer by rotating both said first and second thumb levers concurrently.

10. The computer pointing device of claim 4 additionally comprising:
said first thumb lever and said second thumb lever rotatably engaged to said connecting member at a respective first bottom edges adjacent to said connecting member, of said respective outer surfaces of said first thumb lever an said second thumb lever;
said means for electronic switching having a first switching component adapted for generating a first said input signal when moved to an activated position;
said means for electronic switching having a second switching component adapted for generating a second said input signal when moved to an activated position;
said first switching component moved to said activated position by rotation of said first thumb lever by exerting force on said outer surface of said first thumb lever;
said first switching component moved to said activated position by rotation of said second thumb lever by exerting force on said outer surface of said second thumb lever; and
whereby said user can communicate said first input signal to said computer by rotation of said first thumb lever and said second input signal by rotation of said second thumb lever and can communicate a third input signal to said computer by rotating both said first and second thumb levers concurrently.

11. The computer pointing device of claim 1 wherein said means for translatable communication of said connecting member to said keyboard comprises:
said connecting member having a bottom surface adapted for engagement on and rotation of supporting gears; and
said supporting gears being engaged with said movement detection means which is engaged with said keyboard.

12. The computer pointing device of claim 1 wherein said means for translatable communication of said connecting member to said keyboard comprises:
said connecting member having a support member extending from a bottom surface of said connecting member to a distal end;
said distal end engaged with a mounting surface having frusto conical shape having a center point of said mounting surface positioned below a perimeter edge of said mounting surface.

13. The computer pointing device of claim 12 wherein said means to bias said connecting member to a default position is provided by the distal end of said support member being gravitationally drawn to said center point.

14. The computer pointing device of claim 2 wherein said at least one means for electronic switching comprises a thumb activateable switch adjacent to said first thumb member or said second thumb member; and
said thumb activateable switch positioned to be activateable to said signal generating position by contact with a thumb of said user while said user's hands are in said at home position.

15. The computer pointing device of claim 12 wherein said support member is telescopic thereby providing means to recede said first thumb member and said second thumb member toward the top surface of said keyboard.

16. The computer pointing device of claim 3 additionally comprising:
said respective inner surfaces being curved and having a recessed center section;
respective outer surfaces opposite said respective inner surfaces; and
said respective outer surfaces being longer than said respective inner surfaces and rising above said keyboard at an obtuse angle.

17. The computer pointing device of claim 6 additionally comprising:
said respective inner surfaces being curved and having a recessed center section;
respective outer surfaces opposite said respective inner surfaces;
said respective outer surfaces being longer than said respective inner surfaces and rising above said keyboard at an obtuse angle from said first bottom edge; and
said longer outer surfaces thereby providing means for mechanical advantage to said user exerting said force on said outer surface making easier to move said means for electronic switching to said signal generating position.

18. The computer pointing device of claim 17 additionally comprising:
said respective outer surfaces rising above said keyboard at said obtuse angle providing means to avoid contact with the said thumbs or fingers of said user when traversing above said thumb levers thereby providing means to prevent mistaken input into said computer.
